(19) United States
(12) Patent Application Publication
(10) Pub. No.: US 2022/0032492 A1
(43) Pub. Date: Feb. 3, 2022

(54) AUGER

(71) Applicant: MILWAUKEE ELECTRIC TOOL CORPORATION, Brookfield, WI (US)

(72) Inventors: Max R. Sawa, Palatine, IL (US); Kenneth D. Peterson, Little Suamico, WI (US)

(21) Appl. No.: 17/278,760

(22) PCT Filed: Oct. 30, 2019
(86) PCT No.: PCT/US2019/058701

§ 371 Date: Mar. 23, 2021

Related U.S. Application Data
(60) Provisional application No. 62/754,924, filed on Nov. 2, 2018.

(51) Int. Cl. B27G 15/02

(52) U.S. Cl. CPC B27G 15/02

(57) ABSTRACT

An auger includes a body having a first end and a second end opposite the first end and a shank positioned at the first end of the body. The shank is configured to couple to a power tool. The auger also includes a cutting head positioned at the second end of the body. The cutting head is substantially cone shaped. The cutting head includes a feed screw and a cutting flute.

### CROSS-REFERENCE TO RELATED APPLICATIONS

This application claims priority to U.S. Provisional Patent Application No. 62/754,924, filed Nov. 2, 2018, the entire contents of which are incorporated herein by reference.

### FIELD OF THE INVENTION

The present disclosure relates to tool bits for cutting holes in workpieces and, in particular, to augers.

### SUMMARY

The present invention provides, in one aspect, an auger including a body having a first end and a second end opposite the first end and a shank positioned at the first end of the body. The shank is configured to couple to a power tool. The auger also includes a cutting head positioned at the second end of the body. The cutting head is substantially cone shaped. The cutting head includes a feed screw and a cutting flute.

The present invention provides, in another aspect, an auger including a body having a first end and a second end opposite the first end and a shank positioned at the first end of the body. The shank is configured to couple to a power tool. The auger also includes a cutting head positioned at the second end of the body. The cutting head is substantially cone shaped. The cutting head includes a cutting flute. The cutting flute includes an undercut.

The present invention provides, in another aspect, an auger including a body having a first end and a second end opposite the first end and a shank positioned at the first end of the body. The shank is configured to couple to a power tool. The auger also includes a cutting head positioned at the second end of the body. The cutting head is substantially cone shaped. The cutting head includes a feed screw and a cutting flute that extends at least partially into the feed screw.

Other aspects of the disclosure will become apparent by consideration of the detailed description and accompanying drawings.

### BRIEF DESCRIPTION OF THE DRAWINGS

FIG. 1 is a side view of an auger.

FIG. 2 is an enlarged view of a cutting head of the auger of FIG. 1.

FIG. 3 is a side view of an alternate cutting head for an auger.

FIG. 4 is a cross-sectional view of the cutting head of FIG. 1 viewed along line 4-4.

FIGS. 5-11 illustrate alternative cutting heads for an auger.

FIG. 12 is a side view of another auger.

FIG. 13 is an enlarged view of a cutting head of the auger of FIG. 12.

FIG. 14 is a cross-sectional view of the cutting head of FIG. 12 viewed along line 14-14.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

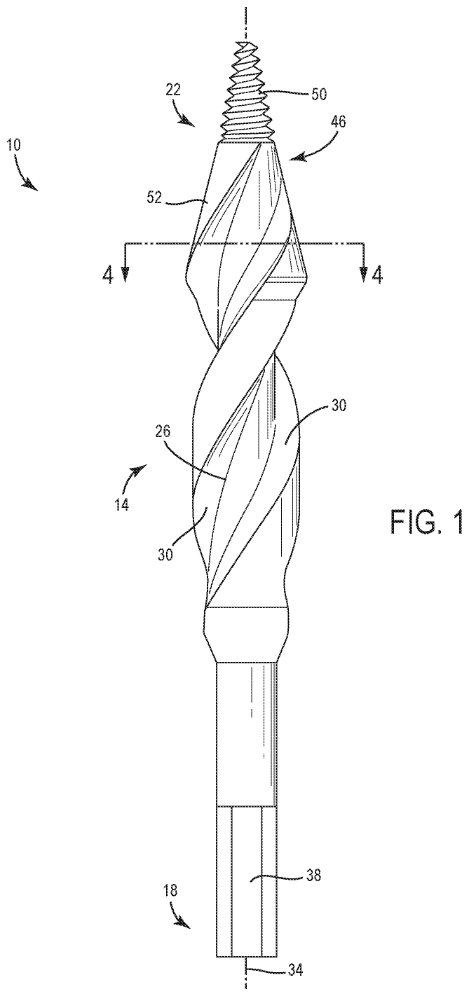

FIGS. 1-4 illustrate an auger 10 for use with a power tool, such as, for example, a drill, a driver drill, an impact driver, and the like. The auger 10 may be used to cut holes or drill into a workpiece such as wood and the like. The auger 10 may also be referred to as a cutting tool or a cutting bit.

As shown in FIG. 1, the auger 10 includes a body 14 with a first or rearward end 18 and a second or workpiece-engaging end 22. The rearward end 18 includes a shank 38 that is configured to couple to the power tool. In the illustrated embodiment, the shank 38 is hex shaped, and is configured to be received in a hex shaped socket of the power tool.

A stem 26 extends from the rearward end 18 to the workpiece-engaging end 22 along an axis 34. The axis 34 defines an axis of rotation that the auger 10 rotates about during a drilling operation. In the illustrated embodiment, the stem 26 has a substantially constant diameter. The stem 26 includes body flutes 30 that helically wrap around the stem 26 and extend along a length of the axis 34. In the illustrated embodiment, the auger 10 includes a pair of flutes 30. In other embodiments, the auger 10 may include a greater or fewer number of flutes 30. For example, the auger 10 may include a single flute.

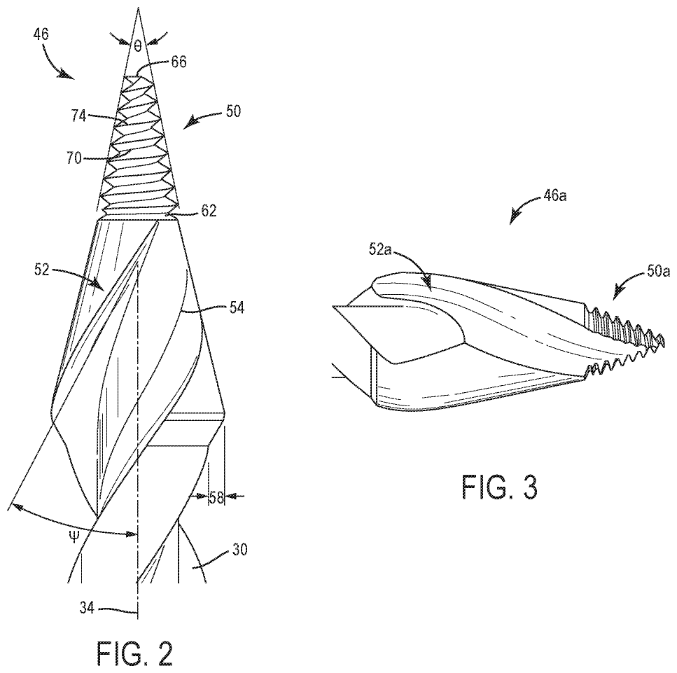

A cutting head 46 is located at the workpiece-engaging end 22 of the body 14. As shown in FIG. 2, the cutting head 46 includes a feed screw 50 and cutting flutes 52 disposed between the body flutes 30 and the feed screw 50. The cutting flutes 52 transition into the body flutes 30. In the illustrated embodiment, the cutting head 46 is substantially cone shaped, such that a cutting head angle θ₁ is constant along a length of the cutting head 46 (i.e., the feed screw 50 and the cutting flutes 52). The cutting head angle θ₁ is the included angle of the cutting head 46. In some embodiments, the cutting head angle θ₁ may be greater than 15 degrees. In other embodiments, the cutting head angle θ₁ may be less than 30 degrees. In still other embodiments, the cutting head angle θ₁ may be between 15 degrees and 30 degrees. In the illustrated embodiment, the cutting head angle θ₁ is about 25 degrees.

In the illustrated embodiment, a maximum diameter of the cutting head 46 represents a maximum diameter of the auger 10. In the illustrated embodiment, the maximum diameter of the cutting head 46 is greater than the diameter of the body flutes 30. An axial relief 58 provides a clearance between the cutting head 46 and the body flutes 30. The axial relief 58 includes a chamfer that transitions from the cutting head 46 (particularly, the cutting flutes 52) to the body flutes 30. In other embodiments, the maximum diameter of the cutting head 46 is substantially equivalent to the diameter of the stem 26.

In the illustrated embodiment, the feed screw 50 is a solid feed screw. The feed screw 50 includes a base 62 adjacent the cutting flutes 52 and a tip 66 distal the cutting flutes 52. A feed screw surface 70 extends between the base 62 and the tip 66, and a thread 74 wraps around the feed screw surface 70.

The cutting flutes 52 wrap around the cutting head 46 and include cutting edges 54. Each cutting flute 52 defines a helix angle ψ₁ relative to the axis 34. In the illustrated embodiment, the helix angle ψ₁ is generally constant along the length of the cutting flutes 52. In other embodiments, the helix angle ψ₁ may vary (e.g., increase or decrease) along the length of the cutting flutes 52.

In the illustrated embodiment, the cutting edges 54 are hardened to increase strength. In some embodiments, hardening the cutting edges 54 is achieved by welding a second material to the cutting edges 54. In other embodiments, hardening the cutting edges 54 may be achieved by cladding, heat treatment, and the like.

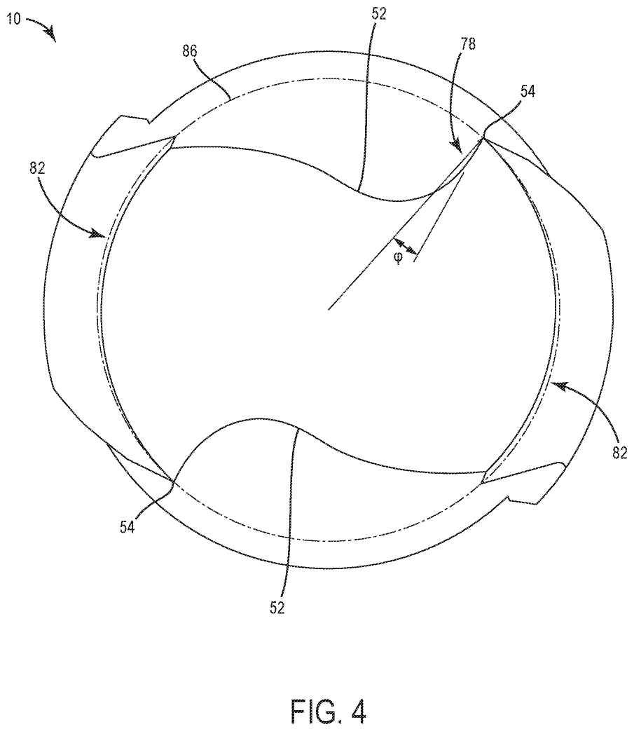

FIG. 3 illustrates a cutting head 46a having a non-solid feed screw 50a that may alternatively be used with the auger 10. In the illustrated embodiment, cutting flutes 52a of the cutting head 46a also extend through the feed screw 50a to a tip of the feed screw 50a. The cutting flutes 52a create a chip breaker feature within the feed screw 50a.

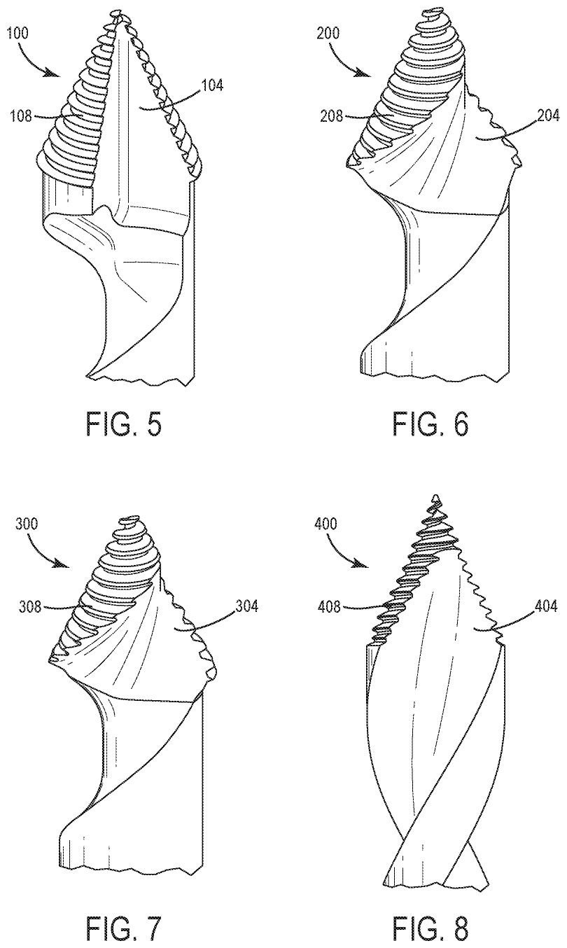

As shown in FIG. 4, each cutting flute 52 of the auger 10 includes an undercut 78. Each undercut 78 defines an undercut angle φ measured from the cutting edge 54 to a radial center of the cutting flute 52. The undercut angle φ is greater than 0 degrees. In some embodiments, the undercut angle φ may be between 0 and 20 degrees. In other embodiments, the undercut angle φ₁ may be between 5 and 15 degrees. The undercut 78 helps make clean cuts in a workpiece during cutting operations.

The illustrated cutting head 46 also includes a radial relief 82. The radial relief 82 decreases an outer diameter of the cutting head 46 in a circumferential direction away from each of the cutting edges 54. In other words, the outer diameter of the cutting head 46 decreases relative to an imaginary circle 86 circumscribed by the cutting edges 54.

In use, the shank 38 is connected to a power tool to rotate the auger 10 about the axis 34. The tip 66 of the feed screw 50 is positioned on a surface to be drilled (e.g., a piece of wood). As the auger 10 is driven (e.g., rotated by the power tool), the feed screw 50 pulls the auger 10 into the surface. The cutting edges 54 of the cutting flutes 52 break up the surface and form a hole. Hardening the cutting edges 54 allows the cutting edges 54 to cut through hard materials (e.g., nails, screws, etc.) that may be present in the surface. Additionally, the axial relief 58 (FIG. 2) and the radial relief 82 (FIG. 4) reduce cutting forces on the auger 10, which in turn reduce the drag on the auger 10 and the power consumption of the tool. The helical shape of the cutting flutes 52 and the body flutes 30 direct material (e.g., woodchips) away from the feed screw 50 and out of the hole produced by the auger 10.

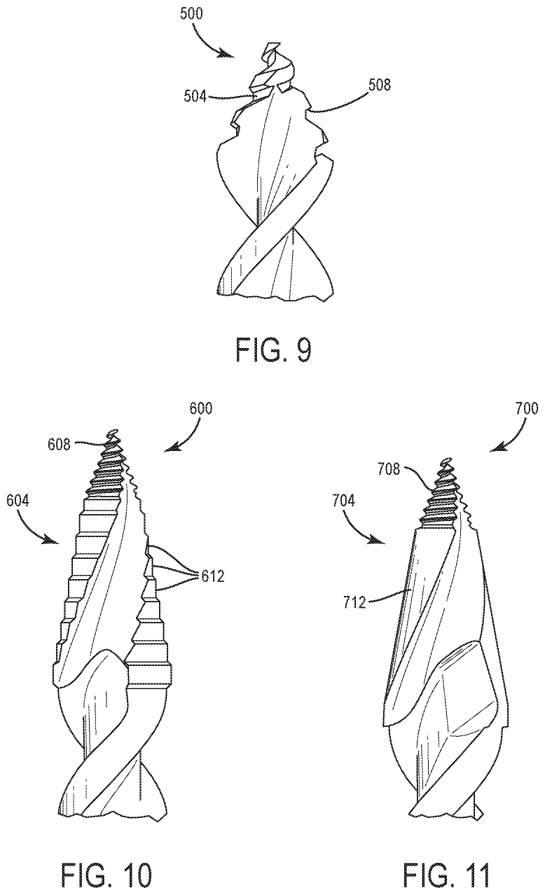

FIGS. 5-11 illustrate alternative cutting heads 100, 200, 300, 400, 500, 600, 700 that can be used with the auger 10. The cutting head 100 of FIG. 5 includes a straight flute 104 extending through a feed screw 108. The straight flute 104 extends parallel to the axis 34 (FIG. 1) of the auger 10.

The cutting head 200 of FIG. 6 includes a curved flute 204 extending through a feed screw 208. The curved flute 204 is helically wrapped relative to the axis 34 (FIG. 1) of the auger 10.

The cutting head 300 of FIG. 7 also includes a curved flute 304 extending through a feed screw 308. In this embodiment, the curved flute 304 smoothly transitions into a cutting flute of the auger 10.

The cutting head 400 of FIG. 8 also includes a curved flute 404 that extends through a feed screw 408 and smoothly transitions into a cutting flute of the auger 10.

The cutting head 500 of FIG. 9 includes a feed screw 504 having a relatively large thread 508.

The cutting head 600 of FIG. 10 includes a stepped portion 604 formed between a feed screw 608 and a body of the auger 10. The stepped portion 604 includes a series of axially-stacked, progressively increasing diameter steps 612, similar to a step drill bit.

The cutting head 700 of FIG. 11 includes a cone portion 704 formed between a feed screw 708 and a body of the auger 10. The cone portion includes 704 a continuous outer surface 712 that gradually increases in diameter as the outer surface 712 extends away from the feed screw 708.

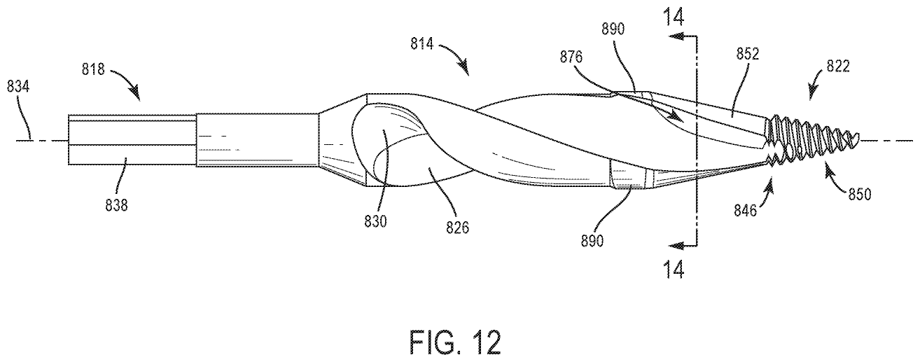

FIGS. 12-14 illustrate another auger 810 for use with a power tool, such as, for example, a drill, a driver drill, an impact driver, and the like. The auger 810 is substantially similar to the auger 10 of FIGS. 1-4, and only differences will be described below. Similar components include the same reference number, plus “800”.

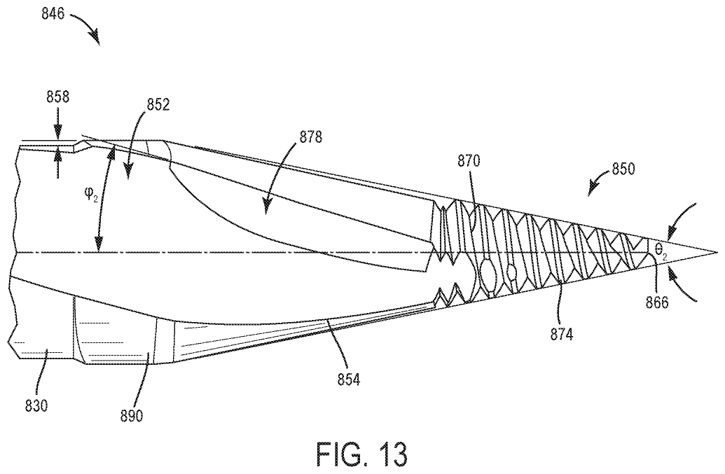

As shown in FIGS. 12 and 13, a cutting head 846 of the auger 810 includes a feed screw 850 and cutting flutes 852 disposed between body flutes 830 and the feed screw 850. In the illustrated embodiment, the cutting head 846 is substantially cone shaped, such that a cutting head angle θ₂ (FIG. 13) is constant along a length of the cutting head 846 (i.e., the feed screw 850 and the cutting flutes 852).

In the illustrated embodiment, the cutting head 846 includes a land 890 at an end of the cutting head 846. The land 890 extends in a direction substantially parallel with respect to a longitudinal axis 834 of the auger 810. The land 890 also has a generally constant diameter. The illustrated land 890 is also obliquely angled with respect to the cutting head angle θ₂. A transition from the conical portion of the cutting head 846 to the land 890 is substantially smooth (i.e., no sharp edges). The land 890 has a diameter equal to a maximum diameter of the cutting head 846, which also represents a maximum diameter of the auger 810. In the illustrated embodiment, the maximum diameter of the cutting head 846 is greater than the diameter of the body flutes 830. An axial relief 858 provides a clearance between the cutting head 846 (e.g., the land 890) and the body flutes 830. The axial relief 858 includes a chamfer that transitions from the land 890 to the body flutes 830. In other embodiments, the maximum diameter of the cutting head 846 is substantially equal to the diameter of the stem 826.

As shown in FIG. 13, the cutting flutes 852 of the cutting head 846 extend into the feed screw 850 along a portion of a length of the feed screw 850. The cutting flutes 852 create a chip breaker feature within the feed screw 850.

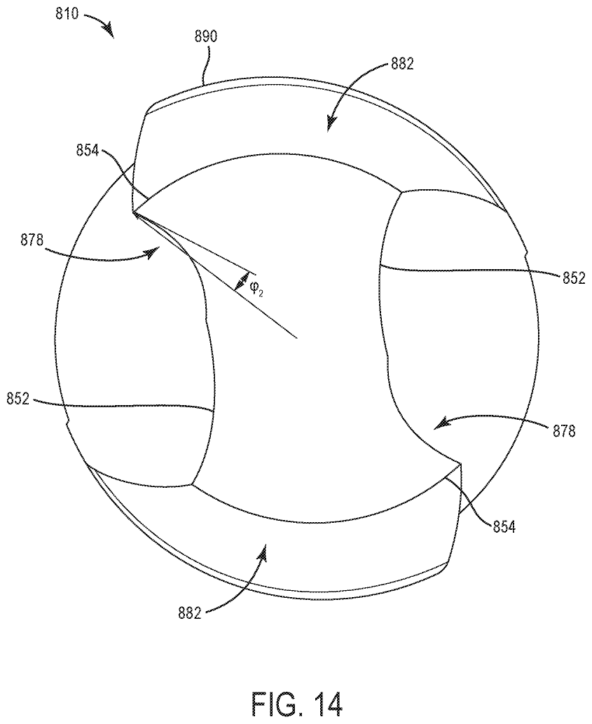

As shown in FIG. 14, the cutting flutes 852 of the auger 810 include an undercut 878. Each undercut 878 defines an undercut angle φ₂ measured from the cutting edge 854 to a radial center of the cutting flute 852. The undercut angle φ₂ is greater than 0 degrees. In some embodiments, the undercut angle φ₂ is between 0 and 20 degrees. In other embodiments, the undercut angle φ₂ is between 5 and 15 degrees. The undercut 878 helps make clean cuts in a workpiece during cutting operations. In the illustrated embodiment, the undercuts 878 extend substantially along a length of the cutting head 846 between the land 890 and the feed screw 850.

In use, the shank 838 is connected to a power tool to rotate the auger 810 about the axis 834. The tip 866 of the feed screw 850 is positioned on a surface to be drilled (e.g., a piece of wood). As the auger 810 is driven (e.g., rotated by the power tool), the feed screw 850 pulls the auger 810 into the surface. The cutting edge 854 of the cutting flutes 852 break up the surface and form a hole. The land 890 creates a clean hole (e.g., a substantially smooth, circular hole). The land 890 also assists in smoothing and cleaning the hole (e.g., removing jagged edges) as it travels through the surface.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

Various features of the invention are set forth in the following claims.

1. An auger comprising:
a body having a first end and a second end opposite the first end;
a shank positioned at the first end of the body, the shank configured to couple to a power tool; and
a cutting head positioned at the second end of the body, the cutting head being substantially cone shaped, the cutting head including a feed screw and a cutting flute;
wherein an axial relief is defined between the cutting head and the body.

2. The auger of claim 1, wherein the body includes a body flute that transitions into the cutting flute.

3. The auger of claim 1, wherein the cutting flute includes an undercut.

4. The auger of claim 1, wherein the cutting flute at least partially extends into the feed screw.

5. The auger of claim 1, wherein the cutting flute extends between the body and the feed screw.

6. The auger of claim 1, wherein the cutting flute is helical.

7. The auger of claim 1, wherein the cutting head defines a cutting head angle, the cutting head angle is constant along a length of the cutting head.

8. The auger of claim 7, wherein the length includes the feed screw and the cutting flute.

9. The auger of claim 1, wherein a maximum diameter of the cutting head defines a maximum diameter of the auger.

10. The auger of claim 9, wherein the maximum diameter of the cutting head is greater than a diameter of the body.

11. (canceled)

12. An auger comprising:
a body having a first end and a second end opposite the first end;
a shank positioned at the first end of the body, the shank configured to couple to a power tool; and
a cutting head positioned at the second end of the body, the cutting head being substantially cone shaped, the cutting head including a cutting flute, the cutting flute including an undercut;
wherein an axial relief is defined between the cutting head and the body.

13. The auger of claim 12, wherein the cutting head further includes a feed screw.

14. The auger of claim 13, wherein the cutting flute partially extends into the feed screw.

15. The auger of claim 12, wherein the cutting flute is helical.

16. The auger of claim 12, wherein the cutting head further includes a land at an end of the cutting head that is adjacent the body.

17. The auger of claim 16, wherein the land defines a maximum diameter of the auger.

18. The auger of claim 17, wherein the maximum diameter is greater than a diameter of the body.

19. The auger of claim 12, wherein the cutting flute defines a cutting edge, and the undercut defines an undercut angle measured from the cutting edge to a radial center of the cutting flute that is greater than zero degrees.

20. An auger comprising:
a body having a first end and a second end opposite the first end;
a shank positioned at the first end of the body, the shank configured to couple to a power tool; and
a cutting head positioned at the second end, the cutting head being substantially cone shaped, the cutting head including a feed screw and a cutting flute that extends at least partially into the feed screw;
wherein the cutting flute is helical.

21. The auger of claim 1, wherein the axial relief includes a chamfer that transitions from the cutting head to the body.
